(19) United States
(12) Patent Application Publication
(10) Pub. No.: US 2003/0007431 A1
(43) Pub. Date: Jan. 9, 2003

(54) Multi-layer disk recording/reproducing apparatus and focus jump method

(76) Inventor: Kiyoshi Tateishi, Tsurugashima-shi (JP)

Correspondence Address: NIXON & VANDERHYE P.C., 8th Floor, 1100 North Glebe Road, Arlington, VA, 22201-4714, US

(21) Appl. No.: 10/189,522

(22) Filed: Jul. 8, 2002

(30) Foreign Application Priority Data
Jul. 6, 2001 (JP) 2001-207012

(51) Int. Cl. G11B 7/095; G11B 7/135

(52) U.S. Cl. 369/44.23; 369/94; 369/112.02; 369/44.27

(57) ABSTRACT

The present invention provides a multi-layer disk recording/reproducing apparatus that records information on a multi-layer disk having a plurality of recording layers or reproduces the information from the multi-layer disk. The objective lens condenses the light from a light source on the recording layers, and the focus actuator moves the objective lens so that the light forms a focused light spot on the recording layers. The a spherical aberration correcting mechanism is provided on a light path between the light source and the objective lens, and it corrects the spherical aberration generated by the multi-layer disk. The control device starts the movement of the focus actuator after the start of the movement of the spherical aberration correcting mechanism when performing the focus jump operation.

### BACKGROUND OF THE INVENTION

1. Field of the Invention:

The present invention relates to a technical field of a recording/reproducing apparatus for recording the information on a multi-layer optical disk or reproducing the recorded information. More particularly, the present invention relates to a focus control technology for moving an information recording/reading position by an optical pickup between a plurality of layers of a multi-layer optical disks.

2. Description of Related Art

In recent years, as a high-density optical disk such as DVD, so-called multi-layer disk having a plurality of recording layers is known. When reproducing the recorded information from such a multi-layer disk or when recording the information on the multi-layer disk, it is needed to move the information reproducing/recording position by an optical pickup between a plurality of layers of the multi-layer optical disk. For example, in the case of a two-layer disk, when moving the reproducing position from a first layer to a second layer, a focus position of an objective lens (namely, a spot position of a laser), which is included in an optical pickup, is moved from a first layer to a second layer (this is referred to as “focus jump”).

As a problem arising upon reproducing an optical disk, a problem of a spherical aberration has been known. In many cases, the spherical aberration arises from displacement of thickness from a set value and/or unevenness of overcoat layer of an optical disk (it is also referred to as “a cover layer”). This spherical aberration makes the returned light from the optical disk deformed, disabling correct recording and reproducing of information.

In the case of a DVD, a numerical aperture (NA) of the objective lens of the optical pickup to be used for a DVD reproducing apparatus is about 0.6, and a distance between the layers of the two-layer DVD is about 55 μm. These values are decided in the standard such that the spherical aberration arising from the thickness of the overcoat layer becomes sufficiently small, and hence there is no problem of the spherical aberration in the DVD. Therefore, according to the DVD reproducing apparatus designed to reproduce the multi-layer disk, when performing the focus jump between a plurality of layers, the spherical aberration is not particularly become a problem.

However, if the optical disk becomes more high-density in future and the NA of the objective lens becomes higher, it is supposed that the influence due to the spherical aberration becomes larger. In fact, using of the objective lens having the NA of 0.8 is under consideration in accordance with the high-density of the optical disk. Since the spherical aberration is increased according to the NA of the objective lens, the distortion arises in a focus error signal due to the influence of the spherical aberration. As a result, it is not possible to realize the stable focus jump.

In order to solve such kind of problems, it is suggested to provide a mechanism for correcting the spherical aberration. For example, according to Japanese Patent Application Laid-Open under No. 2000-131603, in order to correct the spherical aberration generated in the case of using the objective lens having the high NA, i.e., NA=0.8, it is suggested that a correcting mechanism which includes a combination lens is provided in an optical pickup.

Further, according to Japanese Patent Application Laid-Open under No. 10-269611, it is suggested that a spherical aberration correcting mechanism by the use of a liquid crystal is provided in the optical pickup of the reproducing apparatus for the high-density multi-layer optical disk.

If the spherical aberration correcting mechanism is used in this way, it is necessary to simultaneously control both of the focus actuator and the spherical aberration correcting mechanism so as to perform the focus jump from a certain recording layer to another recording layer. For example, in the case of performing the focus jump from the first recording layer to the second recording layer, in addition to moving the focus position of the laser spot from the first recording layer to the second recording layer by driving the focus actuator, it is also necessary to correct the spherical aberration with respect to the second recording layer by driving the spherical aberration correcting mechanism.

However, as opposed to the fact that the focus actuator is designed to be generally light in weight, for example, as seen in a voice coil type or the like and its speed of response is fast, the spherical aberration correcting mechanism is designed so that its speed of response is slower about ten times in comparison with the focus actuator. Accordingly, for example, if the jump operation of the focus actuator and the spherical aberration correcting mechanism are commenced simultaneously after receiving an instruction of the focus jump, the operation of the spherical aberration correcting mechanism is too much slower than that of the focus actuator. As a result, since the focus actuator tries to focus on the second recording layer during the spherical aberration correcting mechanism is not functioning yet with respect to the second recording layer (namely, the spherical aberration is arising), distortion is introduced to the focus error signal. Therefore, the focus jump operation may be unstable, or the focus actuator may fail in the focus jump.

### SUMMARY OF THE INVENTION

The present invention has been achieved in order to solve the above problems. It is an object of the present invention to enable stable focus jump even in the case of reproducing a high-density multi-layer disk by the use of an objective lens having a high NA.

According to one aspect of the present invention, there is provided a multi-layer disk recording/reproducing apparatus for recording information on a multi-layer disk having a plurality of recording layers and/or reproducing information from the multi-layer disk, including: an objective lens which condenses a light from a light source on the recording layers; a focus actuator which moves the objective lens to form a focused light spot of the light on the recording layers; a spherical aberration correcting mechanism which is provided on a light path between the light source and the objective lens and which corrects spherical aberration generated by the multi-layer disk; and a control device which starts a movement of the focus actuator after a start of a movement of the spherical aberration correcting mechanism when performing a focus jump operation to move the light spot from a first recording layer to a second recording layer of the multi-layer disk.

In accordance with the multi-layer disk recording/reproducing apparatus which is constituted as described above, a light from a light source is condensed on a recording surface of the multi-layer disk by an objective lens so that the information is recorded or reproduced. The objective lens is moved by the focus actuator, and the objective lens is controlled so that a light spot is formed on a recording layer in focus. Further, in order to correct the spherical aberration generated by the multi-layer disk, the spherical aberration correcting mechanism is provided. In the operation of the focus jump, at first, the spherical aberration correcting mechanism is moved, and then the focus actuator is moved. Since it takes a longer time to move the spherical aberration correcting mechanism from a position corresponding to the first recording layer to a position of the second recording layer than a time required for the focus actuator to move a light spot from the first recording layer to the second recording layer, it becomes possible to perform the focus jump correctly by moving the focus actuator after moving the spherical aberration correcting mechanism.

The control device may move the spherical aberration correcting mechanism from a position corresponding to the first recording layer to a position corresponding to the second recording layer, and may start the movement of the focus actuator when the spherical aberration correcting mechanism is moved to an approximate mid point between the position corresponding to the first recording layer and the position corresponding to the second recording layer. By this, the movement of the focus actuator is started when the spherical aberration correcting mechanism is approaching the second recording layer, and hence the spherical aberration correcting mechanism has already approached when the focus actuator has moved to the second recording layer. Therefore, it is possible to perform the focus servo operation correctly on the second recording layer.

The control device may include: a timer which starts counting a time when the movement of the spherical aberration correcting mechanism is started; and a unit which starts the movement of the focus actuator when a counting time of the timer becomes a predetermined time. By this, the movement of the focus actuator has been started when a timer counts a predetermined time, and hence it is possible to easily control a movement start timing of the focus actuator.

The predetermined time may be substantially equivalent to ½ of a time required for the movement of the spherical aberration correcting mechanism from the position corresponding to the first recording layer to the position corresponding to the second recording layer. By this, it is possible to start the movement of the focus actuator when the spherical aberration correcting mechanism arrives at the approximate mid point between a position corresponding to the first recording layer and a position corresponding to the second recording layer.

The multi-layer disk recording/reproducing apparatus may further include a position sensor which detects a movement amount of the spherical aberration correcting mechanism, and the control device may start the movement of the focus actuator based on the output of the position sensor. According to this, the movement amount of the spherical aberration correcting mechanism is detected by the position sensor, so that it is possible to decide a movement start timing of the focus actuator in accordance with the actual position of the spherical aberration correcting mechanism.

The multi-layer disk recording/reproducing apparatus may further include: a photo detector which receives a returned light from the multi-layer disk and outputs an electrical signal; and a unit which generates a reproduction signal or a control signal of recorded information based on the electrical signal, and the control device may start the movement of the focus actuator based on a change in an amplitude of the reproduction signal or the control signal.

In this case, a reproducing signal of the recorded information such as an RF signal or the like or a control signal such as a tracking error signal and a wobble signal or the like is generated from an electric signal corresponding to a return light from the multi-layer disk. The amplitude of these signals is decreased when the correction of the spherical aberration by the spherical aberration correcting mechanism is insufficient, so that it is possible to determine the movement amount of the spherical aberration correcting mechanism by monitoring the amplitude of these signals and to start the movement of the focus actuator at an appropriate timing.

The spherical aberration correcting mechanism may include: a moving mechanism which moves at least one lens of a plurality of lenses arranged in parallel with each other on a light axis; and a driving motor which drives the moving mechanism. In addition, the driving motor may include a step motor, and the control device may include: a unit for driving the moving mechanism by inputting pulses to the step motor; and a unit which starts the movement of the focus actuator based on a number of pulses which have been input to the step motor. By this, it is possible to control the movement amount of the spherical aberration correcting mechanism by the number of pulses which are input in the step motor, so that a position sensor or the like is not particularly needed.

The spherical aberration correcting mechanism may include: a liquid crystal panel having a plurality of liquid crystal portions controlled independently of each other; and a control circuit which drives the plural liquid crystal portions independently of each other. The spherical aberration correcting mechanism may control a refraction index of the plural liquid crystal portions by applying a voltage to the plural liquid crystal portions independently to correct the spherical aberration.

According to another aspect of the present invention, there is provided a focus jump method of moving a light from a first recording layer to a second recording layer of the multi-layer disk by means of a multi-layer disk recording/reproducing apparatus including: an objective lens which condenses a light from a light source on the recording layers; a focus actuator which moves the objective lens to form a focused light spot of the light on the recording layers; a spherical aberration correcting mechanism which is provided on a light path between the light source and the objective lens and which corrects spherical aberration generated by the multi-layer disk, the focus jump method including the steps of: a first step of starting a movement of the spherical aberration correcting mechanism corresponding to the first recording layer to a position corresponding to the second recording layer when a timing a focus jump has arrived; and a second step of starting a movement of the focus actuator starting the movement of the focus actuator after the movement of the spherical aberration correcting mechanism.

In accordance with the focus jump method, in the operation of the focus jump, at first, the spherical aberration correcting mechanism is moved, and then the focus actuator is moved. It takes a longer time to move the spherical aberration correcting mechanism from a position corresponding to the first recording layer to a position of the second recording layer than a time required for the focus actuator to move a light spot from the first recording layer to the second recording layer. Hence, it becomes possible to perform the focus jump correctly by moving the focus actuator after moving the spherical aberration correcting mechanism.

The second step may start the movement of the focus actuator when a predetermined time has passed after a start of the movement of the spherical aberration correcting mechanism, and the predetermined time may be substantially equivalent to ½ of a time required for the movement of the spherical aberration correcting mechanism from the position corresponding to the first recording layer to the position corresponding to the second recording layer.

By this, the movement of the focus actuator is started when the spherical aberration correcting mechanism is approaching the second recording layer, so that the spherical aberration correcting mechanism has also approached when the focus actuator has moved to the second recording layer. Therefore, it is possible to perform the focus servo correctly on the second recording layer.

The second step may start the movement of the focus actuator when the spherical aberration correcting mechanism is moved to an approximate mid point between the position corresponding to the first recording layer and the position corresponding to the second recording layer. Therefore, it is possible to perform the focus servo correctly after the focus actuator has moved to the second recording layer.

The second step may include the steps of: detecting an amplitude of a reproduction signal or a control signal of recorded information generated based on a returned light from the multi-layer disk; and starting the movement of the focus actuator when the amplitude becomes equal to an amplitude which is obtained when the spherical aberration correcting mechanism arrives at the approximate mid point between the position corresponding to the first recording layer and the position corresponding to the second recording layer.

By this, a reproducing signal of the recorded information such as an RF signal or the like or a control signal such as a tracking error signal and a wobble signal or the like is generated from an electric signal corresponding to a return signal from the multi-layer disk. The amplitude of these signals is decreased when the correction of the spherical aberration by the spherical aberration correcting mechanism is insufficient, so that it is possible to determine the movement amount of the spherical aberration correcting mechanism by monitoring the amplitude of these signals and to start the movement of the focus actuator at an appropriate timing.

According to still another aspect of the present invention, there is provided a multi-layer disk recording/reproducing apparatus for recording information on a multi-layer disk having a plurality of recording layers or reproducing the information from the multi-layer disk, including: an objective lens which condenses a light from a light source on the recording layers; a focus actuator which moves the objective lens to form a focused light spot of the light on the recording layers; and a control device which performs a focus jump to an adjacent recording layer by moving the focus actuator from a present recording layer to the adjacent recording layer and making the light spot in focus on the adjacent recording layer, and performs the focus jump across three or more recording layers by repeating the focus jump to the adjacent recording layer.

In accordance with the multi-layer disk recording/reproducing apparatus, in the case of performing the focus jump across three or more layers, the focus jump is performed by repeating the processing such that, at first, the focus actuator is moved to the adjacent recording layer, and then, when the light spot is brought into focus by the focus servo, the focus actuator is further moved to the adjacent next recording layer, and then the light spot is focused by the focus servo. Therefore, it is possible to perform the focus jump across many layers without the focus servo being unstable.

According to still another aspect of the present invention, there is provided a multi-layer disk recording/reproducing apparatus for recording information in a multi-layer disk having a plurality of recording layers or reproducing the information from the multi-layer disk, including: an objective lens which condenses a light from a light source on the recording layers; a focus actuator which moves the objective lens to form a focused light spot of the light on the recording layers; a spherical aberration correcting mechanism which is provided on a light path between the light source and the objective lens and corrects spherical aberration generated by the multi-layer disk; and a control device which performs a focus jump across three or more recording layers by moving the spherical aberration correcting mechanism toward a position corresponding to a target recording layer and repeating an operation for moving the focus actuator to a next recording layer when the spherical aberration correcting mechanism arrives at an approximate mid point between a position corresponding to the present recording layer and a position corresponding to the next recording layer.

In accordance with the multi-layer disk recording/reproducing apparatus, in the case of performing the focus jump across three or more layers, at first, the spherical aberration correcting mechanism is moved to a position corresponding to the target recording layer. During the movement, when the spherical aberration correcting mechanism arrives at the approximate mid point between a position corresponding to the current recording layer and a position corresponding to the next recording layer, the focus actuator is moved to the next recording layer. By the repetition of the operation, the focus jump of the three or more layers is performed. Accordingly, it is possible to perform the focus jump across many layers without the focus servo being unstable.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a block diagram illustrating a configuration of an optical system of an optical disk recording/reproducing apparatus according to the present invention;

FIG. 2 is a block diagram illustrating a configuration of a focus control system of the optical disk recording/reproducing apparatus according to the present invention;

FIG. 3 is a timing chart illustrating a manner of the focus jump in the case of simultaneously driving a focus actuator and a spherical aberration correcting mechanism;

FIG. 4 is a timing chart illustrating a manner of the focus jump in the case of driving a focus actuator and a spherical aberration correcting mechanism according to the present invention;

FIG. 5 shows driving waveforms of the spherical aberration correcting mechanism in the case that the spherical aberration correcting mechanism is configured by a direct current motor;

FIG. 6 is a flowchart illustrating a focus jump process in the case that the spherical aberration correcting mechanism is configured by a step motor;

FIG. 7A is a diagram illustrating an example of a drive circuit of the step motor;

FIGS. 7B and 7C show waveforms of drive signals supplied to the drive circuit shown in FIG. 7A;

FIG. 8 is a flowchart showing a first controlling method of the movement start timing of the focus actuator;

FIG. 9 is a timing chart showing the waveforms of respective units of the focus control system according to a second controlling method of the movement start timing of the focus actuator;

FIG. 10 is a flowchart showing a second controlling method of the movement start timing of the focus actuator;

FIG. 11 is a timing chart showing the waveforms of respective units of the focus control system according to the third controlling method of the movement start timing of the focus actuator;

FIG. 12 is a flowchart showing the third controlling method of the movement start timing of the focus actuator;

FIGS. 13A and 13B are diagrams illustrating the constitution of the spherical aberration correcting mechanism by the use of a liquid crystal panel;

FIG. 14 is a timing chart showing the waveforms of respective units of the focus control system in the case of performing the focus jump across three or more layers according to the focus jump method of the present invention; and

FIG. 15 is a timing chart showing the waveforms of respective units of the focus control system in the case of simultaneously driving the focus actuator and the spherical aberration correcting mechanism and performing the focus jump across three or more layers.

### DESCRIPTION OF THE PREFERRED EMBODIMENTS

The preferred embodiments according to the present invention will be explained with reference to the attached drawings.

[1] Configuration of Apparatus

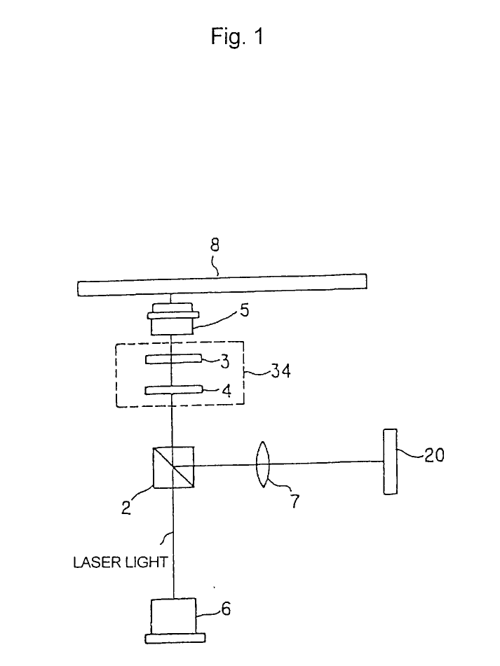

FIG. 1 illustrates a configuration of an optical system of an optical pickup to be used for an optical disk recording/reproducing apparatus. In FIG. 1, a laser light output from a laser source 6 passes through a polarizing beam splitter 2 and an spherical aberration correcting mechanism 34, and is condensed by an objective lens 5. Thus, the laser light is irradiated onto an information recording surface of an optical disk 8, which is a multi-layer disk. A return light which is reflected from the information recording surface of the optical disk 8 passes through the objective lens 5, the spherical aberration correcting mechanism 34 and the polarizing beam splitter 2, and is irradiated on a photo detector 20 through a condensing lens 7.

For example, the spherical aberration correcting mechanism 34 is constructed by a combination of lenses including a positive lens 3 and a negative lens 4 as shown. The positive lens 3 and the negative lens 4 can move in the direction of the optical axis, so that they cancel the spherical aberration which is generated due to the error and the unevenness of the thickness of the overcoat layer of the optical disk by generating the positive or negative spherical aberration depending on the relative position of the lenses 3 and 4.

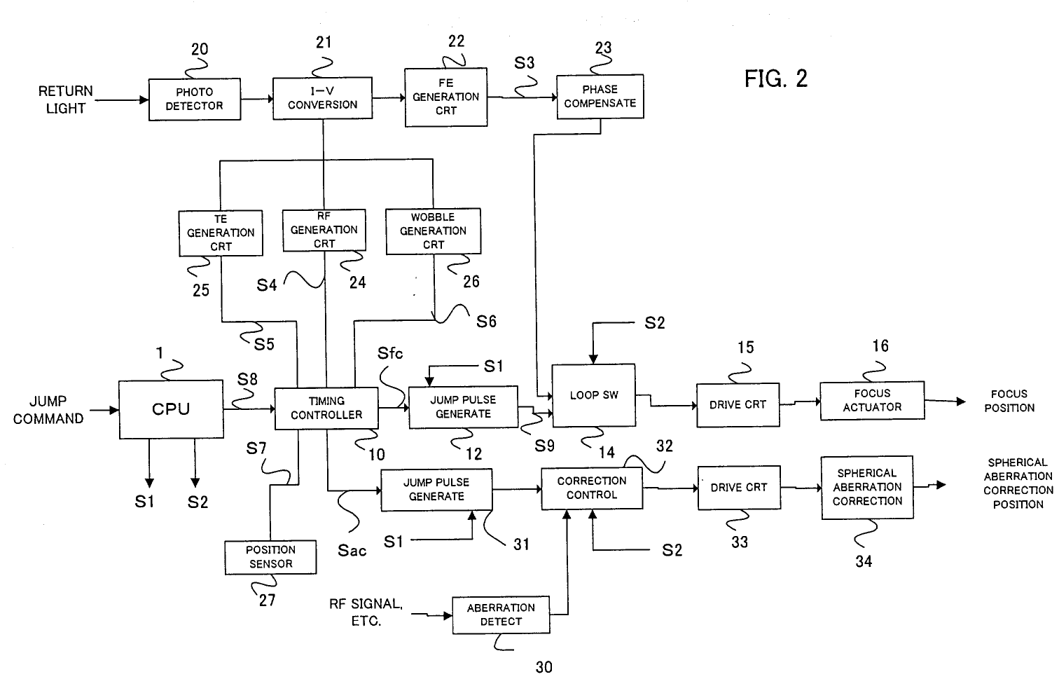

FIG. 2 illustrates a configuration of a focus control system of the optical disk recording/reproducing apparatus according to the present invention. In FIG. 2, elements for constructing a focus servo loop include a photo detector 20, an I-V converter 21, a focus error generation circuit 22, a phase compensation device 23, a loop switch 14, a drive circuit 15 and a focus actuator 16. A focus servo loop is formed by these elements and a path of a laser light which runs from the laser source 6 to the optical disk 8 and then is reflected by the optical disk 8 to reach the photo detector 20.

Further, as the elements for correcting the spherical aberration, a correction control unit 32, a drive circuit 33, a spherical aberration correcting mechanism 34 and a position sensor 27 are included. As the elements for performing the focus jump, a timing controller 10, a jump pulse generation circuit 12 and a jump pulse generation circuit 31 are included. Further, it is a matter of course that a tracking error generation circuit 25, an RF signal generation circuit 24 and a wobble signal generation circuit 26 are used for their original purposes. However, in addition to them, according to the present invention, they are also used for deciding a timing to operate the focus actuator 16 or the spherical aberration correcting mechanism 34. The details of this will be described in later.

Next, the operations of respective elements will be described.

The photo detector 20 receives the return light from the optical disk 8 to supply the current corresponding to its light amount to the I-V converter 21. The I-V converter 21 generates an electric signal in accordance with the current value and supplies it to the focus error generation circuit 22, the tracking error generation circuit 25, the RF signal generation circuit 24 and the wobble signal generation circuit 26.

The focus error generation circuit 22 generates a focus error signal S3 by a known astigmatism method or the like to supply it to the phase compensation device 23. The phase compensation device 23 corrects a phase of the focus error signal S3, and supplies the corrected signal to the loop switch 14.

On the other hand, the RF signal generation circuit 24 generates a RF signal S4, which indicates sum of the return lights which enter the photo detector 20, from the output of the I-V converter 21, and supplies the RF signal S4 to the timing controller 10. In the same way, the tracking error generation circuit 25 generates a tracking error signal S5 from the output of the I-V converter 21 by the use of a known method such as a push-pull method or the like, and supplies the tracking error signal S5 to the timing controller 10. The wobble signal generation circuit 26 detects the wobbling of a guide groove, which is formed in advance on an unrecorded rewritable optical disk, generates a wobble signal S6 and supplies the wobble signal S6 to the timing controller 10.

Although the illustration is omitted in FIG. 2, these signals S4 to S6 are supplied not only to the controller 10 but also to the corresponding signal processing units, respectively. In other words, the RF signal S4 is transmitted to a signal reproducing system, and the tracking error signal S5 and the wobble signal S6 are transmitted to a tracking control system and a time axis control system.

The loop switch 14 is turned on when the optical pickup is reproducing a recorded signal on the optical disk 8 and the optical pickup is recording the information, and the loop switch 14 supplies the output signal of the phase compensation device 23 to the drive circuit 15. Thus, the focus servo is closed, and the laser light forms a focused light spot on the optical disk 8 by the servo control operation to read and write the information. On the other hand, at the time of the focus jump, the loop switch 14 is turned off and the focus servo is opened, so that a jump signal S9 output from the jump pulse generation circuit 12 is supplied to the drive circuit 15. As a result, the drive circuit 15 drives the focus actuator 16 so that the laser light is brought into focus on other recording layer. Then, the loop switch 14 is turned on again and the focus servo is closed on the other recording layer after the jump, so that the focused state is established on the recording layer after the jump.

The drive circuit 15 drives the focus actuator 16 on the basis of the focus error signal input through the loop switch 14 when the loop switch 14 is turned on (namely, when the focus servo is closed), and the drive circuit 15 brings the laser light spot into focus on the target recording layer of the optical disk. Further, the drive circuit 15 drives the focus actuator 16 in accordance with the jump pulse supplied from the jump pulse generation circuit 12 so as to move the laser light spot to other recording layer when the loop switch 14 is turned off (namely, when the focus servo is opened).

On the other hand, the drive circuit 33 in the spherical aberration correction system side drives the spherical aberration correcting mechanism 34 on the basis of an aberration detection signal input from an aberration detection unit 30 through the correction control unit 32, at the time of reproducing the normal information from the optical disk 8. The aberration detection unit 30 detects the size and the direction of the spherical aberration component from the reproduction signal such as the RF signal or the like, generates an aberration detection signal and supplies it to the drive circuit 33 through the correction control unit 32. The drive circuit 33 drives the spherical aberration correcting mechanism 34, on the basis of the aberration detection signal, to cancel the spherical aberration.

In one embodiment, as shown in FIG. 1, the spherical aberration correcting mechanism 34 includes the lenses 3 and 4. The spherical aberration correcting mechanism 34 cancels the spherical aberration on the basis of the aberration detection signal from the aberration detection unit 30 by moving one or both of the lenses 3 and 4 in the optical axis direction to adjust the distance between the lens 3 and the lens 4.

In the focus jump, by making reference to a switching signal S2 generated from the CPU 1, the correction control unit 32 supplies the jump pulse generated by the jump pulse generation circuit 31 to the drive circuit 33. The drive circuit 33 moves the lens 3 and/or the lens 4, constituting the spherical aberration correcting mechanism 34, in the optical axis direction on the basis of the jump pulse. When the focus jump is completed, the correction control unit 32 again supplies the aberration detection signal, which is output from the aberration detection unit 30, to the drive circuit 33.

The CPU 1 receives a focus jump command and supplies a focus jump instruction signal S8 to the timing controller 10. The timing controller 10 inputs a focus trigger signal Sfc to the jump pulse generation circuit 12 at the side of the focus actuator, and inputs a correction trigger signal Sac in the jump pulse generation circuit 31 at the side of the spherical aberration correcting mechanism. It is noted that, when a user instructs the jump of a reproduction position on the optical disk by means of an input device (not illustrated), the focus jump command is transmitted from the input device to the CPU 1. Further, even in the case that the reproduction position is moved from a certain recording layer to other recording layer during the continuous reproduction of the recording information, the CPU 1 recognizes that the focus jump should be performed and inputs the focus jump instruction signal S8 to the timing controller 10.

Further, the CPU 1 supplies a direction instruction signal S1, which instructs a direction for moving the laser light spot by means of the focus actuator 16 and the spherical aberration correcting mechanism 34, to the jump pulse generation circuits 12 and 31. For example, in the case of the two-layer disk, the direction instruction signal S1 serves to identify the jump from the first recording layer to the second recording layer or the jump from the second recording layer to the first recording layer.

The CPU 1 generates a switching signal S2 for controlling opening and closing of a focus servo loop including the focus actuator 16, and supplies the switching signal S2 to the loop switch 14. The CPU 1 generates a switching signal S2 so that the loop switch 14 is turned on at the time of normal recording and reproduction, and the loop switch 14 is turned off during the focus jump.

This switching signal S2 is also transmitted to the correction control unit 32. By making reference to the switching signal S2, the correction control unit 32 supplies the jump pulse signal from the jump pulse generation circuit 31 to the drive circuit 33 at the time of the focus jump, and the correction control unit 32 cancels the spherical aberration by controlling the drive circuit 33 on the basis of the aberration detection signal from the aberration detection unit 30 at the time of the normal recording and reproduction other than the focus jump.

The position sensor 27 detects the movement amount of the spherical aberration correcting mechanism 34 and transmits the detected amount to the timing controller 10. The timing controller 10 controls the movement start timing of the focus actuator 16 based on the movement amount, but the details of this will be described later.

[2] Focus Jump Method

Next, a basic principle of a focus jump method according to the present invention will be explained below. As described above, in order to prevent the influence of the spherical aberration, a spherical aberration correcting mechanism is provided in an optical disk recording/reproducing apparatus using the objective lens having the high NA, approximately NA=0. 8. Accordingly, in the case of performing the jump between the layers of the multi-layer disk, in order to jump the laser light spot from a certain recording layer to another recording layer, it is necessary to move the focus actuator as well as to move the spherical aberration correcting mechanism to a position corresponding to the recording layer to which the laser light spot is moved. In this case, the response of the focus actuator is relatively fast and it moves quickly if the jump pulse is given thereto. However, the response of the spherical aberration correcting mechanism is slow, and it takes relatively a long time for the spherical aberration correcting mechanism to move to a position corresponding to the recording layer after the jump, when the jump pulse is given. Therefore, if the movements of the focus actuator and the spherical aberration correcting mechanism are simultaneously started, the focus servo operation is started under a condition that the spherical aberration correcting mechanism has not moved from the recording layer before the jump yet. Therefore, the focus error signal is distorted by accepting much influence of the spherical aberration, and it is not possible to perform the focus servo operation correctly.

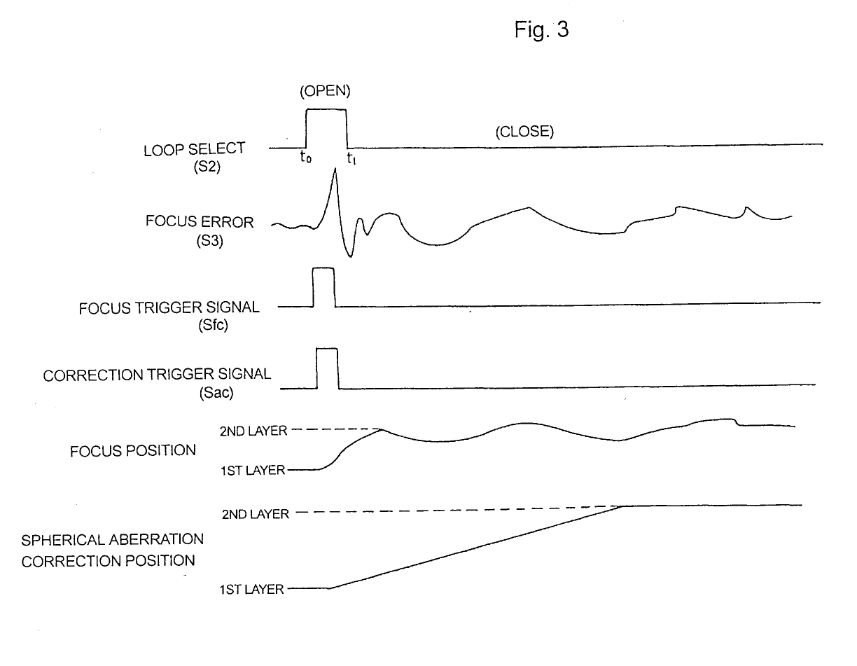

FIG. 3 shows this example. FIG. 3 shows signal waveforms of respective units of the focus servo system shown in FIG. 2 when the optical pickup jumps from the first recording layer to the second recording layer of the multi-layer disk. The CPU 1 gives the focus jump instruction signal S8 to the timing controller 10, and outputs a loop selection signal S2 to open the focus servo loop. Further, concurrently with opening the focus servo loop, the timing controller 10 outputs the focus trigger signal Sfc and the correction trigger signal Sac to start to drive the focus actuator 16 and the spherical aberration correcting mechanism 34.

Near the time t1 when the focus servo loop, once opened, is closed by the selection signal S2, the focus position of the laser nearly reaches to the second recording layer, however, the position of the spherical aberration correcting mechanism hardly moves from the position corresponding to the first recording layer. It is because the spherical aberration correcting mechanism has a response slower than the focus actuator so that it takes a longer time for the spherical aberration correcting mechanism to move from the first recording layer to the second recording layer. As a result, the focus error signal S3 after the time t1 is disordered, and the focus position cannot stay on the second recording layer.

In consideration of these points, according to the present invention, the focus actuator and the spherical aberration correcting mechanism do not start to move simultaneously. Namely, the spherical aberration correcting mechanism starts to move first, and then the focus actuator starts to move after the spherical aberration correcting mechanism has moved for some degree. Thus, the focus actuator moves to the second recording layer under a condition that the spherical aberration correcting mechanism has proceeded toward a position corresponding to the second recording layer to some extent, so that the influence of the spherical aberration has already been decreased at a point of time when the focus actuator has arrived at the second recording layer. Hence, the focus error signal is not distorted due to the influence of the spherical aberration. Thereby, the focus servo, which has been moved to the second recording layer, becomes stable.

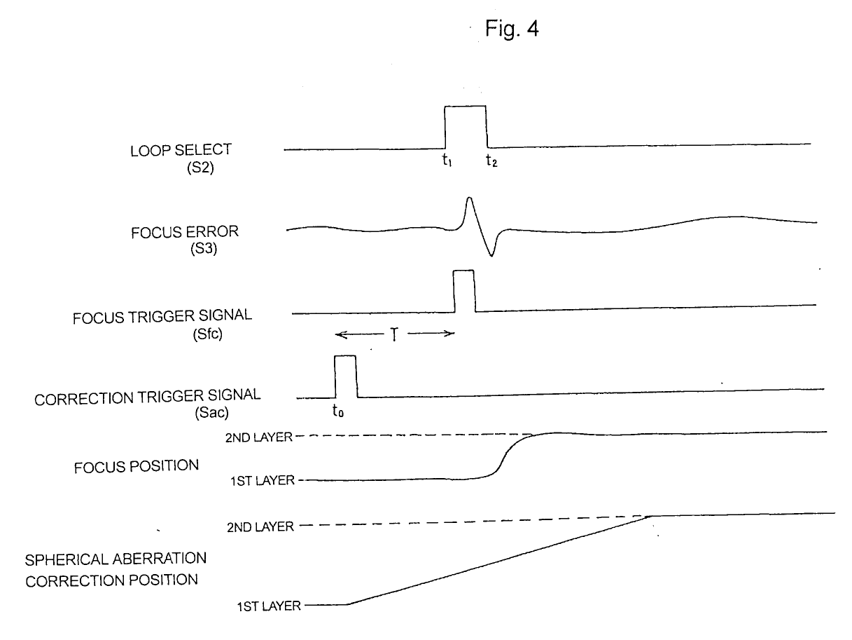

FIG. 4 shows this operation. As shown in FIG. 4, the timing controller 10 supplies the correction trigger signal Sac to the jump pulse generation circuit 31 at a time t0 to start the movement of the spherical aberration correcting mechanism 34 from a position corresponding to the first recording layer to a position corresponding to the second recording layer. Then, after a predetermined time T has passed after the spherical aberration correcting mechanism 34 stated to move, the timing controller 10 supplies the focus trigger signal Sfc to the jump pulse generation circuit 12 to start the movement of the focus actuator 16 from the first recording layer to the second recording layer. At a time t2 when the focus servo loop is closed, the spherical aberration correcting mechanism 34 approaches the second recording layer, and the focus actuator 16 also approximately reaches the second recording layer (see, the focus position signal). Therefore, after the focus servo loop is closed, the focus error signal S3 shows S-shaped waveform, and the focus servo makes progress correctly. As a result, as shown by the waveform of the focus position in FIG. 4, the focus position becomes stable.

In this way, according to the present invention, in the focus jump, at first, the movement of the spherical aberration correcting mechanism is started, and then the movement of the focus actuator is started when the spherical aberration correcting mechanism has proceeded to some extent. Therefore, it is possible to stabilize the focus servo after moving the layers.

Next, the manner of deciding a time to start the movement of the focus actuator will be considered. It is preferable that a delay time T of the start of the movement of the focus actuator 16 after the start of the movement of the spherical aberration correcting mechanism 34 is set to be about ½ of a time required for the spherical aberration correcting mechanism 34 to move from the first recording layer to the second recording layer. The reason is as follows. If the start of the movement of the focus actuator 16 is too early after the movement of the spherical aberration correcting mechanism 34 has been started, as described above, the focus actuator 16 starts the focus servo operation with respect to the second recording layer under a condition that the spherical aberration correcting mechanism 34 is still located on the first recording layer, and hence the focus servo becomes unstable. On the other hand, if the start of the movement of the focus actuator 16 is too late after the movement of the spherical aberration correcting mechanism 34 has been started, despite the spherical aberration correcting mechanism 34 has approached the position corresponding to the second recording layer, the focus actuator 16 remains on the first recording layer. As a result, the operation of the focus actuator 16 becomes unstable before the focus jump. Therefore, by setting the predetermined delay time T to about ½ of a time required for the spherical aberration correcting mechanism 34 to move from the first recording layer to the second recording layer, it is possible make the focus actuator 16 jump when the spherical aberration correcting mechanism 34 is approaching the second recording layer, so that the focus jump may be stable. In this view, it is not necessary to set the predetermined delay time T to be exactly ½ of the moving time between the layers of the spherical aberration correcting mechanism 34. In fact, it is preferable that the delay time T is set individually depending on a response of the spherical aberration correcting mechanism 34 (i.e., the time required for the movement from the first recording layer to the second recording layer) and a response of the focus actuator 16 (i.e., the time required for the movement from a position corresponding to the first recording layer to a position corresponding to the second recording layer).

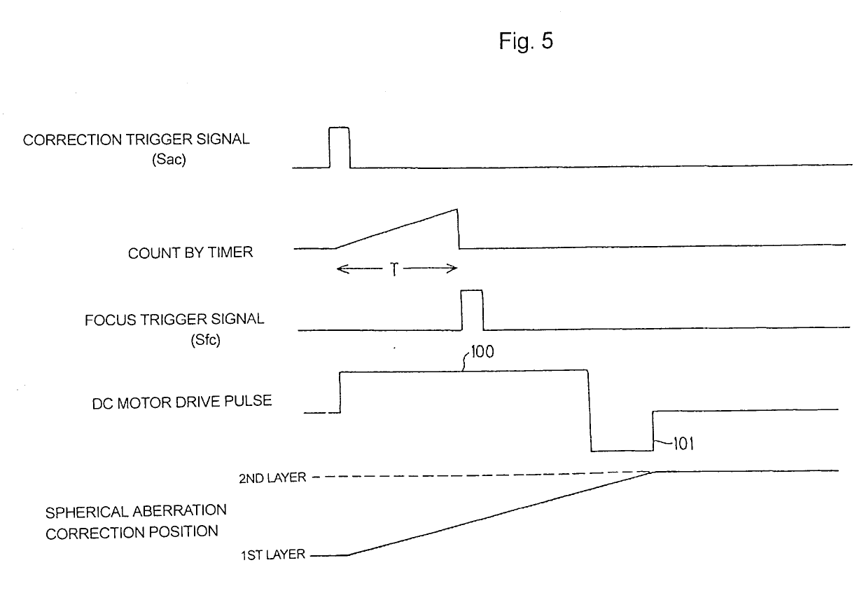

Next, the actual operation of the spherical aberration correcting mechanism 34 will be explained with reference to FIGS. 5 to 7. According to the present embodiment, the spherical aberration correcting mechanism 34 includes a combination of two lenses, namely, the lenses 3 and 4, and the spherical aberration correcting mechanism 34 is designed to change the correction amount of the spherical aberration by varying the distance between two lenses 3 and 4. Specifically, for example, if one of the lenses is fixed and other lens is moved along the optical axis, it is possible to change the distance between the lenses 3 and 4.

FIG. 5 shows motor driving waveforms in the case that a direct current (DC) motor is used for driving the lenses. The movement amount of the DC motor is basically controlled by a width of the driving pulse to be applied to the motor. In the case of moving the lens from a certain point for a predetermined distance by the DC motor, at first, a positive pulse of a predetermined width for moving the motor is applied, and then a negative pulse for breaking the motor is applied.

In FIG. 5, if it is instructed to move the spherical aberration correcting mechanism 34 by the correction trigger signal Sac from the timing controller 10, the drive circuit 33 applies the positive pulse 100 of a predetermined width to the DC motor of the spherical aberration correcting mechanism 34, and then the drive circuit 33 applies the negative pulse 101 of a predetermined width to move one of the lenses composing the spherical aberration correcting mechanism 34 from a position corresponding to the first recording layer to a position corresponding to the second recording layer (see, the graph at a spherical aberration correcting position).

The timing controller 10 starts counting, by means of an internal timer counter, at a point of time when it gives the correction trigger signal Sac to the jump pulse generation circuit 31, and the timing controller 10 gives the focus trigger signal Sfc to the jump pulse generation circuit 12 at a point of time when the predetermined time T has passed. In this time, the loop switch 14 opens the focus loop, and the drive circuit 15 moves the focus actuator 16 from the first recording layer to the second recording layer in accordance with the jump pulse from the jump pulse generation circuit 12.

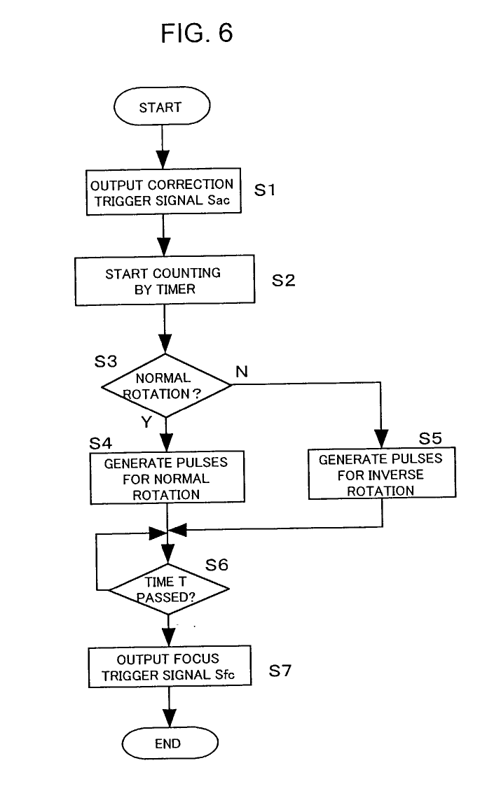

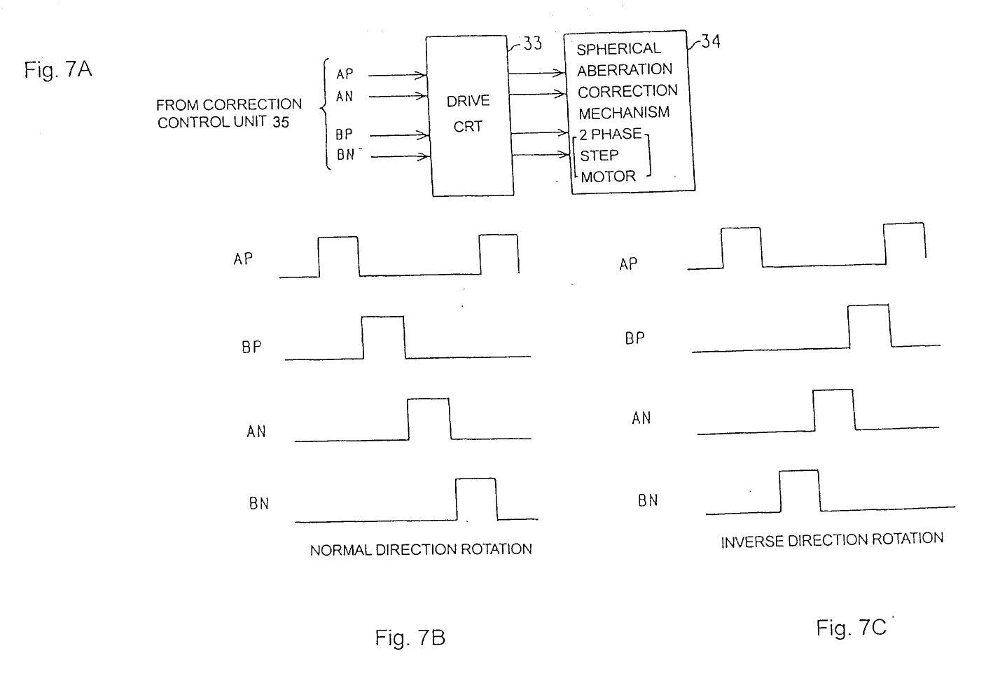

Next, the operation of driving the lens of the spherical aberration correcting mechanism 34 by the use of a step motor will be explained with reference to FIG. 6 and FIG. 7. FIG. 6 is a flowchart illustrating a control example of the step motor, and FIG. 7A shows a connection between the drive circuit 33 and the spherical aberration correcting mechanism 34 (in this case, a two-phase motor). Further, FIG. 7B and FIG. 7C show examples of pulse waveforms to be input to the drive circuit 33.

As shown in FIG. 7A, the drive circuit 33 receives four pulse signals AP, BP, AN and BN from the correction control unit 32, and supplies them to the two-phase motor composing the spherical aberration correcting mechanism 34. The step motor is constructed to rotate only for a predetermined angle if one pulse is supplied thereto, and hence the rotation amount of the step motor may be controlled by changing the number of pulses supplied. FIG. 7B shows an example of a pulse combination to be supplied to rotate the step motor composing the spherical aberration correcting mechanism 34 in a normal rotational direction, and FIG. 7C shows an example of a pulse combination to be supplied to rotating the step motor in the inverse rotational direction. It is possible to control the rotational direction of the step motor by changing the input order of the pulses to be input to the four input terminals of the step motor.

FIG. 6 is a flowchart illustrating a control example of this step motor, and this control is carried out by the CPU 1 and the timing controller 10. At first, the timing controller 10 receives the jump instruction signal S8 from the CPU 1, outputs the correction trigger signal Sac to the jump pulse generation circuit 31 (step S1), and activates the internal timer counter to start counting the predetermined delay time T (step S2). Next, by referring to the rotational direction signal S1 which is output from the CPU 1, the timing controller 10 decides the rotational direction of the step motor composing the spherical aberration correcting mechanism 34 (step S3). In the case of rotating the step motor in a positive direction, the timing controller 10 generates a pulse combination for the positive direction rotation shown in FIG. 7B (step S4). On the other hand, in the case of rotating the step motor in the inverse rotational direction, the timing controller 10 generates a pulse combination for the inverse direction rotation shown in FIG. 7C (step S5).

Then, the timing controller 10 awaits for the passage of the predetermined time T (step S6). If the predetermined time T has passed, the timing controller 10 inputs the focus trigger signal Sfc in the jump pulse generation circuit 12 (step S7), so as to make the focus actuator 16 jump from the first recording layer to the second recording layer. In the case that the spherical aberration correcting mechanism 34 is configured by the step motor, the spherical aberration correcting mechanism 34 and the focus actuator 16 are controlled as described above.

It is noted that, the above description is directed to the focus jump from the first recording layer to the second recording layer of the optical disk. However, the first recording layer and the second recording layer in this case may be any recording layer in the multi-layer disk. In other words, it is possible to apply the jump method of the present invention to the focus jump from a lower layer to an upper layer of the multi-layer disk as well as the focus jump from an upper layer to a lower layer of the multi-layer disk.

[3] Movement Start Timing of Focus Actuator

Next, the timing control of the movement of the focus actuator will be explained by citing some examples.

(1) First Control Method

According to a first control method, the time T is decided in advance as described above, and the time T is counted by the use of the internal timer counter in the timing controller 10. In other words, as shown in FIG. 4, when supplying the correction trigger signal Sac to the jump pulse generation circuit 31 at the side of the spherical aberration correcting mechanism 34, the timing controller 10 activates the internal timer counter to start counting. Then, when the predetermined time T has passed, the timing controller 10 supplies the focus trigger signal Sfc to the jump pulse generation circuit 12 at the side of the focus actuator. At the same time, the CPU 1 generates a loop selection signal S2. In this way, it is possible to drive the focus actuator 16 after the predetermined time T has passed since the movement of the spherical aberration correcting mechanism is started.

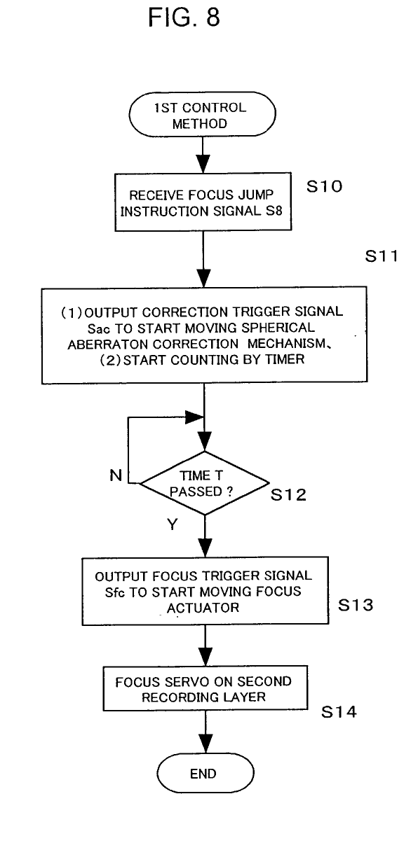

FIG. 8 shows a specific process example of the first control method. The timing controller 10 receives the focus jump instruction signal S8 from the CPU 1, and outputs the correction trigger signal Sac to start the movement of the spherical aberration correcting mechanism 34 (step S10). Additionally, at the same time, the timing controller 10 activates the internal timer counter to start counting the predetermined time T (step S11). Then, when the predetermined time T has passed (step S12; Yes), the timing controller 10 outputs the focus trigger signal Sfc to start the movement of the focus actuator (step S13). Then, after the focus actuator 16 is moved to the second recording layer, the timing controller 10 closes the focus servo to carryout the focus servo operation (step S14). In this way, the focus jump is completed.

As described above, the predetermined delay time T in this case is basically set to be about ½ of the time required for the movement of the spherical aberration correcting mechanism 34 to move from the first recording layer to the second recording layer, for example, several tens msec. However, it is possible to correct this predetermined delay time T in consideration of the specific values of the moving speed of the spherical aberration correcting mechanism 34 and the moving speed of the focus actuator 16.

(2) Second Control Method

According to a second control method, no predetermined time is set like the first control method, but the movement start timing of the focus actuator 16 is decided in accordance with the actual movement amount of the spherical aberration correcting mechanism 34. In other words, the moving condition from the first recording layer to the second recording layer of the spherical aberration correcting mechanism 34 is detected. Then, when the spherical aberration correcting mechanism 34 has moved for about half of the distance between two recording layers, the timing controller 10 generates the focus trigger signal Sfc to start the movement of the focus actuator 16.

Specifically, the position sensor 27 shown in FIG. 2 detects the movement amount of the lenses constituting the spherical aberration correcting mechanism 34. Since the distance between the recording layers of the multi-layer optical disk to be reproduced is defined by the standard of the disk, about ½ of the distance is set as a reference value, and the detected value of the movement amount from the position sensor 27 is compared with this reference value. For example, if the distance between the layers of the optical disk to be reproduced is D, the reference value is set to D/2. If the detected value of the movement amount attains the reference value D/2, it means that the lenses constituting the spherical aberration correcting mechanism 34 is moved to a mid point between a position corresponding to the first recording layer and a position corresponding to the second recording layer. Therefore, at this point, the timing controller 10 generates the focus trigger signal Sfc. In this way, when the spherical aberration correcting position is actually moved to the vicinity of the middle point between a position corresponding to the first recording layer and a position corresponding to the second recording layer, it is possible to start the movement of the focus actuator.

The position sensor 27 to detect the movement amount of the lenses constituting the spherical aberration correcting mechanism 34 may be configured by, for example, a potentiometer or a rotary encoder or the like.

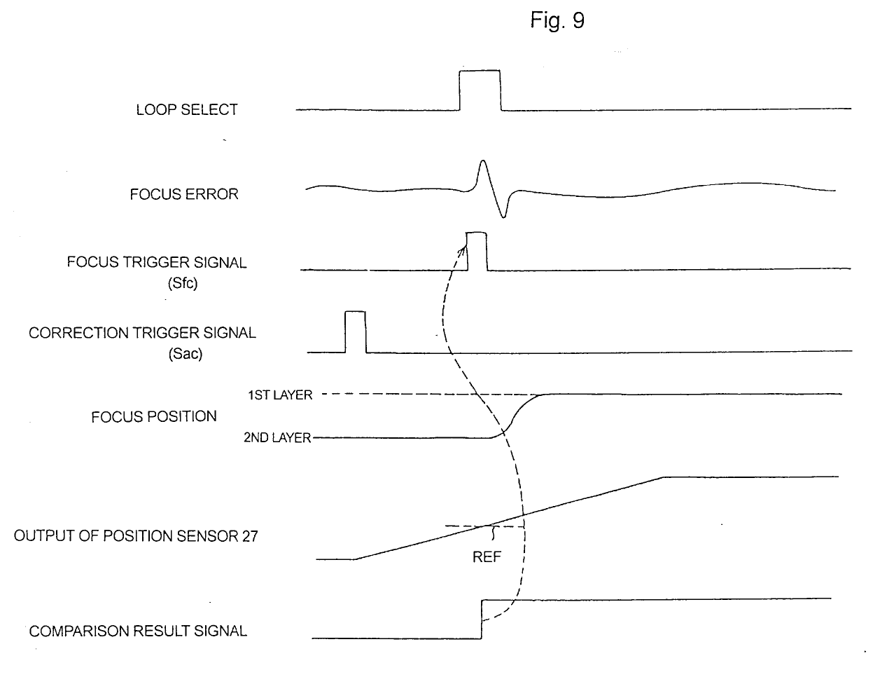

FIG. 9 shows waveforms of respective units of the focus control system in the case of using this method. At first, in order to start the movement of the spherical aberration correcting mechanism 34, a correction trigger signal Sac is output. When the spherical aberration correcting mechanism 34 starts the movement, the level of the output signal S7 of the sensor 27 varies in accordance with this movement. The output signal S7 of the sensor 27 is compared with a predetermined reference value (D/2) by a comparator or the like (not illustrated) which is provided within the timing controller 10. Then, when the output signal S7 of the sensor 27 attains the reference value, a comparison result signal, which is a digitized signal of the output signal S7, is output. At the timing when the level of the comparison result signal changes, the timing controller 10 generates the focus trigger signal Sfc, and supplies this focus trigger signal Sfc to the jump pulse generation circuit 12 to start the movement of the focus actuator 16.

As a modification of this method, in the case that the spherical aberration correcting mechanism 34 is configured by a step motor as described above, the movement amount of the lenses constituting the spherical aberration correcting mechanism 34 may be determined by counting the number of pulses supplied to the step motor, and the position sensor 27 may be omitted. In other words, since the rotation amount of the step motor is determined by the number of pulses input thereto as described above with reference to FIG. 7, the movement amount of the lens to be driven by the step motor is also in proportion to the number of pulses that are input. Therefore, it is possible to obtain the number of pulses to be input to the step motor to move the lenses constituting the spherical aberration correcting mechanism 34 for about ½ of a distance between a position corresponding to the first recording layer and a position corresponding to the second recording layer by calculation. Thus, the reference pulse number may be determined in advance, and the timing controller 10 may generate the focus trigger signal Sfc to start the movement of the focus actuator 16 when the pulses of the reference pulse number are supplied to the spherical aberration correcting mechanism 34. According to this method, it is possible to advantageously omit the position sensor 27 for detecting a position of the lenses constituting the spherical aberration correcting mechanism 34.

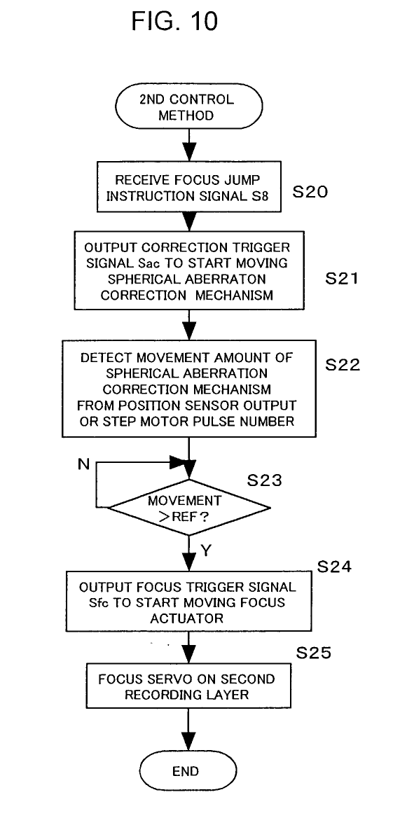

FIG. 10 shows a specific process example of the second control method. The timing controller 10 receives the focus jump instruction signal S8 from the CPU 1 (step S20), outputs a correction trigger signal Sac and starts the movement of the spherical aberration correcting mechanism 34 (step S21). Next, the timing controller 10 determines the movement amount of the spherical aberration correcting mechanism 34 on the basis of the output signal of the position sensor 27 or on the basis of the number of the pulses input to the step motor in the case that the spherical aberration correcting mechanism 34 is configured by the step motor (step S22). Then, when the movement amount becomes larger than the predetermined reference value (step S23: Yes), the timing controller 10 outputs the focus trigger signal Sfc and starts the movement of the focus actuator (step S24). Then, after the focus actuator 16 moves to the second recording layer, the timing controller 10 closes the focus servo to carry out the focus servo operation (step S25). In this way, the focus jump is completed.

(3) Third Control Method

The above-described second control method directly detects the movement amount of the spherical aberration correcting mechanism 34 by the position sensor or by the number of the pulses supplied to the step motor. However, according to the third control method, by the use of a reproduction signal or a control signal obtained by reproducing the optical disk, the movement amount of the optical disk is indirectly determined to decide the movement start timing of the focus actuator 16.

When the laser spot is in focus on the first recording layer, the spherical aberration correction by the spherical aberration correcting mechanism 34 is adapted to the first recording layer. Therefore, when the spherical aberration correcting mechanism 34 is moved from the position corresponding to the first recording layer to the position corresponding to the second recording layer, the correction effect of the spherical aberration is weakened as the spherical aberration correcting mechanism 34 moves away from the first recording layer. Hence, the amplitudes of the RF signal generated from a reading signal of the recorded information on the optical disk, the tracking error signal and the wobble signal of the guide groove which has been provided on the disk in advance or the like are decreased. Therefore, it is possible to indirectly decide how much the spherical aberration correcting mechanism 34 moved by evaluating a degree of the decrease in the amplitudes of the RF signal, the tracking signal or the wobble signal.

Accordingly, by examining the changes in the amplitudes of the RF signal, the tracking signal or the wobble signal, in advance, when the spherical aberration correcting mechanism 34 is moved from the first layer to the second layer, the amplitudes of these signals when the spherical aberration correcting mechanism 34 is moved to the a mid point between the first layer and the second layer are defined as the reference amplitudes. In an actual focus jump operation, by detecting the amplitudes of the RF signal, the tracking error signal or the wobble signal and by comparing them with the predetermined reference amplitude values, the movement of the focus actuator 16 is started when the amplitudes of these signals become equal to the reference amplitude values.

Specifically, by referring to FIG. 1, the timing controller 10 stores the above described reference amplitude values in an internal memory or the like (not illustrated). Then, after starting the movement of the spherical aberration correcting mechanism 34, the timing controller 10 compares any one and more of the RF signal S4, the tracking error signal S5 and/or the wobble signal S6 with the reference amplitude values thus stored in the memory, and outputs the focus trigger signal Sfc to the jump pulse generation circuit 12 at a point of time when the amplitudes of these signals are decreased to the reference amplitude values.

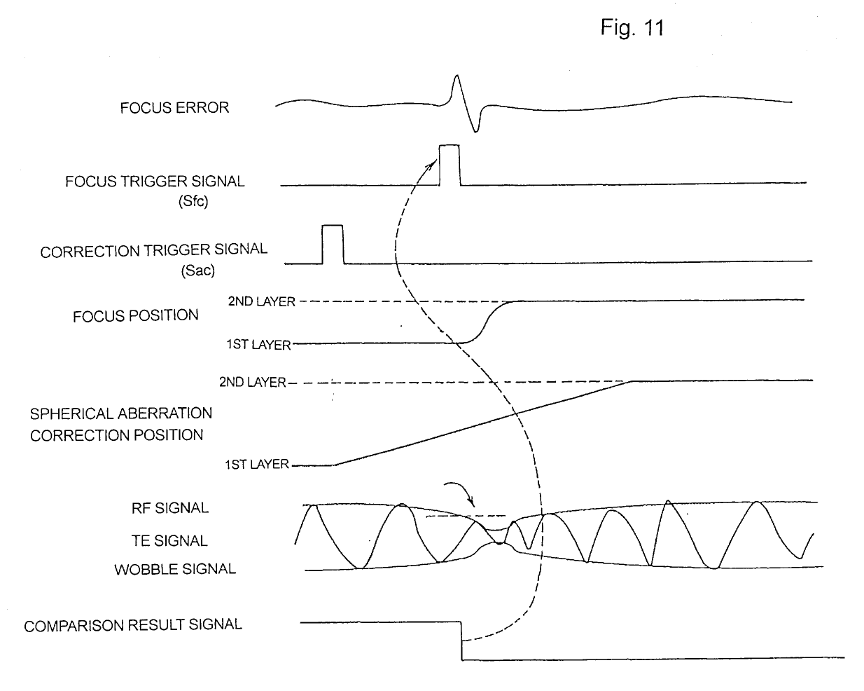

FIG. 11 shows signal waveforms of respective units of the focus control system in the case of using this method. In FIG. 11, at first, the correction trigger signal Sac is output, and the spherical aberration correcting mechanism 34 starts to move. If the amplitudes of the RF signal, the tracking signal or the wobble signal are decreased to the amplitude reference values due to the movement of the spherical aberration correcting mechanism 34, the level of the comparison result signal output from the comparator within the timing controller 10 varies. In response, the timing controller 10 outputs the focus trigger signal Sfc and starts the movement of the focus actuator 16.

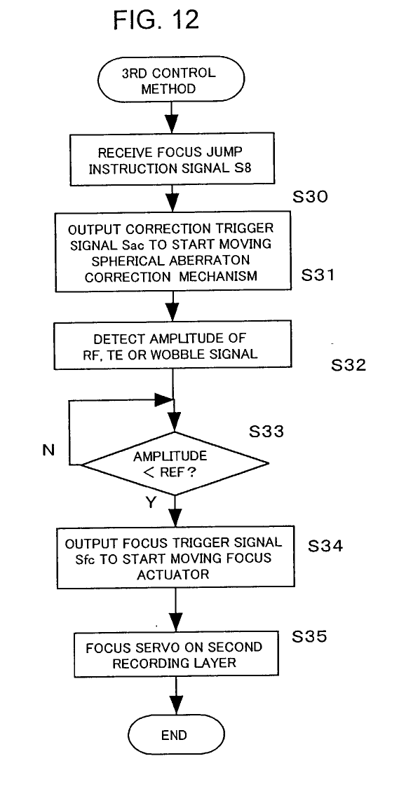

FIG. 12 shows a specific process example of the third control method. The timing controller 10 receives the focus jump instruction signal S8 from the CPU 1 (step S30), outputs the correction trigger signal Sac and starts the movement of the spherical aberration correcting mechanism 34 (step S31). Next, the timing controller 10 detects the amplitudes of the RF signal, the tracking signal or the wobble signal (step S32). Then, if the detected amplitude values are smaller than the predetermined amplitude reference values (step S33: Yes), the timing controller 10 outputs the focus trigger signal Sfc and starts the movement of the focus actuator 16 (step S34). Then, after the focus actuator is moved to the second recording layer, the timing controller 10 closes the focus servo to carry out the focus servo operation. In this way, the focus jump is completed.

According to this method, the movement amount of the spherical aberration correcting mechanism 34 is indirectly decided by the use of the signals generated by recording and reproducing of the normal information, such as the RF signal, the tracking signal or the wobble signal, and the movement of the focus actuator is controlled in accordance with the movement amount of the spherical aberration correcting mechanism 34 decided as above described. Therefore, it is not necessary to provide a special mechanism such as the above described position sensor 27 or the like. In other words, a simple constitution including the memory for storing the reference amplitude values and the level comparator in the timing controller 10 enables the third control method.

It is noted that all of an RF signal S4, a tracking signal S5 and a wobble signal S6 are input to the timing controller 10 in FIG. 1, for the sake of convenience of the explanation. In fact, it is sufficient that one of them is input to the timing controller 10, and the movement amount of the spherical aberration correcting mechanism 34 may be indirectly decided on the basis of the input signal.

As described above, by detecting that the spherical aberration correcting mechanism 34 has moved to an approximately mid point between the first recording layer and the second recording layer by the above various methods, it is possible to control the movement start timing of the focus actuator.

[4] Other Embodiment of Spherical Aberration Correcting Mechanism

Next, other embodiment of the spherical aberration correcting mechanism will be explained below. In the above description, the spherical aberration correcting mechanism is configured by a combination of two lenses. However, in the apparatus according to the present invention, a spherical aberration correcting mechanism of other type may be employed. For example, it is possible for the apparatus according to the present invention to use a spherical aberration correcting mechanism in which a liquid crystal panel is employed, as described in Japanese Patent Application Laid-Open under No. 10-269611.

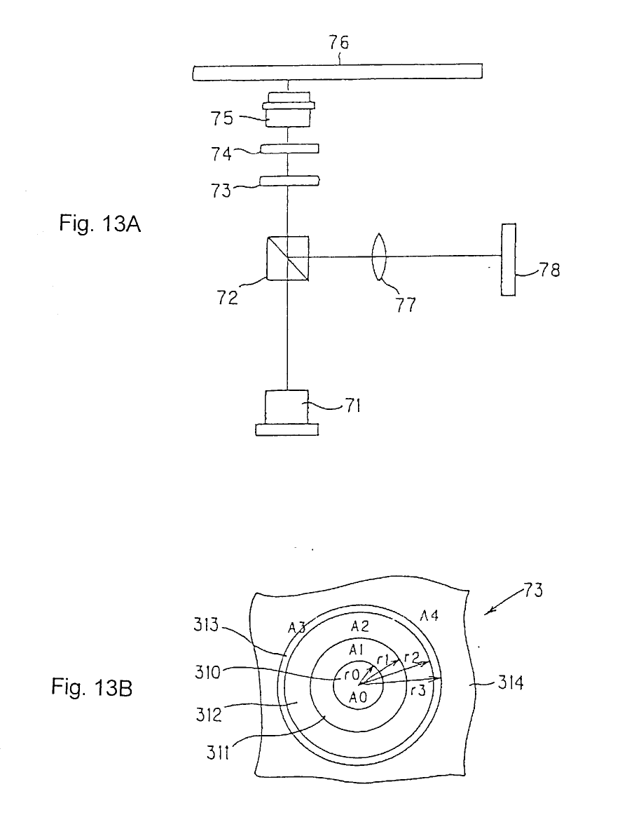

Specifically, a liquid crystal panel as shown in FIG. 13A is provided in an optical pickup. In FIG. 13A, a reference numeral 71 denotes a laser source, a reference numeral 72 denotes a polarized beam splitter, a reference numeral 73 denotes a liquid crystal panel, a reference numeral 74 denotes a ¼ wavelength plate, a reference numeral 75 denotes an objective lens, a reference numeral 76 denotes a multi-layer disk, a reference numeral 77 denotes a condenser lens and a reference numeral 78 denotes an light receiving unit.

The laser beam emitted from the laser source 71 passes through the polarized beam splitter 72, the liquid crystal panel 73 and the wavelength plate 74, and focused on an information recording surface of the multi-layer optical disk 76 by the objective lens 75. The reflected laser light from the information recording surface of the multi-layer disk 76 passes through the objective lens 75, the ¼ wavelength plate 74, the liquid crystal panel 73 and the polarized beam splitter 72 to be brought into focus on the light receiving unit 78 through the condenser lens 77.

In the liquid crystal panel 73, liquid crystal elements sandwiched between by two glass plates (not illustrated) are arranged. A transparent electrode (not shown) at an upper side (or at a lower side) is formed to be concentric electrode pattern, and opposing transparent electrode at the lower side (or the upper side) is formed as corresponding electrode pattern. Valuably controlling the applied voltage of respective electrode pattern portions of the upper and lower transparent electrodes by a liquid crystal panel control circuit 80, the spherical aberration generated by the irregularities in thickness of the recording layers of the multi-layer disk are corrected.

FIG. 13B is a plane view of the liquid crystal panel 73. In the liquid crystal panel 73, liquid elements having refractive index anisotropy are oriented to a predetermined direction between the glass plates. The concentric electrodes 310 to 314, which are the transparent electrode at the upper side (or at the lower side) of the liquid crystal panel 73, are formed on one glass plate, and opposing electrodes 310 to 314 are formed at the lower side (or the upper side) of the liquid crystal panel 73. When the drive voltages are applied to respective electrodes of the liquid crystal panel 73 which is constructed as described above, the orientation of the liquid crystal molecules are changed according to the electric field generated by the applied voltage. This enables the refractive index distribution to be arbitrarily set within a vertical cross sectional plane normal to the travel direction of a light beam which transmits through the liquid crystal panel 73, and hence it is possible to control the phase of the wave surface of the light beam by each divided area of the liquid crystal panel 73. In other words, it is possible to use the liquid crystal panel 73 as a refractive index variable device. Accordingly, by applying different voltages to respective electrodes of the liquid crystal panel 73, respectively, it is possible to cancel the spherical aberration and it is possible to realize the spherical aberration correcting mechanism 34 by the use of the liquid crystal panel.

A spherical aberration correcting mechanism by the use of such a liquid crystal panel also has such a property that its response is slower than that of the focus actuator, similarly to the spherical aberration correcting mechanism configured by the above described combination of the lenses. The spherical aberration correcting mechanism by the use of the liquid crystal panel corrects the spherical aberration by applying different drive voltages to the respective electrode portions and controlling the orientation of the liquid crystal molecules. However, it takes a certain time from the drive voltage is applied till the physical change in the orientation of the liquid crystal molecules is completed. This delay in time (namely, delay in response) is similar to the delay in response arising from a time required by movement of the lens in the spherical aberration correcting mechanism configured by the combination of the lenses. Therefore, in the case of using the spherical aberration correcting mechanism employing the liquid crystal panel, similarly to spherical aberration correcting mechanism configured by the combination of the lenses, such a principle of present invention, that the movement of the focus actuator is started with delay of a predetermined time T after giving the instruction to move the spherical aberration correcting mechanism from the position of the first recording layer to the position of the second recording layer, may be applied.

In this case, it is possible to use the focus control system identical to that used in combination with the spherical aberration correcting mechanism configured by the combination of the lenses as shown in FIG. 1. In other words, it is possible to construct the focus control system identical to that in the spherical aberration correcting mechanism configured by the combination of the lenses, with the exception that the driving signal is different from that of the spherical aberration correcting mechanism configured by the combination of the lenses.

In the case of using such a spherical aberration correcting mechanism 34, according to the above-described first control method and the third control method, it is possible to control the movement start time of the focus actuator. In other words, according to the first control method, the timing controller 10 calculates the predetermined time T from the driving start time of the spherical aberration correcting mechanism 34, and stats the movement of the focus actuator after a predetermined time has passed. Further, according to the third control method, the timing controller 10 indirectly detects the change in condition of the spherical aberration correcting mechanism on the basis of the amplitude change of the RF signal, the tracking error signal and/or the wobble signal generated from the reading signal of an optical disk, and may control the movement start timing of the focus actuator. However, since it is difficult to detect how much the liquid crystal molecules are moved in fact, the second control method cannot be applied to the spherical aberration correcting mechanism employing the liquid crystal panel.

Further, it is also possible to construct a spherical aberration correcting mechanism by combining the above-described spherical aberration correcting mechanism configured by the combination of the lenses with the spherical aberration correcting mechanism using the liquid crystal panel.

[5] Focus Jump Across Three or More Layers

Next, the description will be given of the focus jump control for more than one layer in the multi-layer disk having three or more layers. For example, as a method of focus jump from the first recording layer to the third recording layer in the multi-layer disk having more than two layers, in theory, two methods can be considered. One method is to jump from the first recording layer to the third layer in a single operation. The other method is to jump from the first recording layer to the second layer, and then jump from the second recording layer to the third recording layer. Although the former method is available in theory, it is difficult to control the spherical aberration correcting mechanism and the focus actuator for the focus jump of two or more layers at once. Therefore, according to the present invention, with delaying the movement start of the focus actuator with respect to the movement start of the spherical aberration correcting mechanism, at first, the focus position jumps from the first recording layer to the second recording layer and then the focus position jumps from the second recording layer to the third recording layer after the focus becomes stable on the second recording layer.

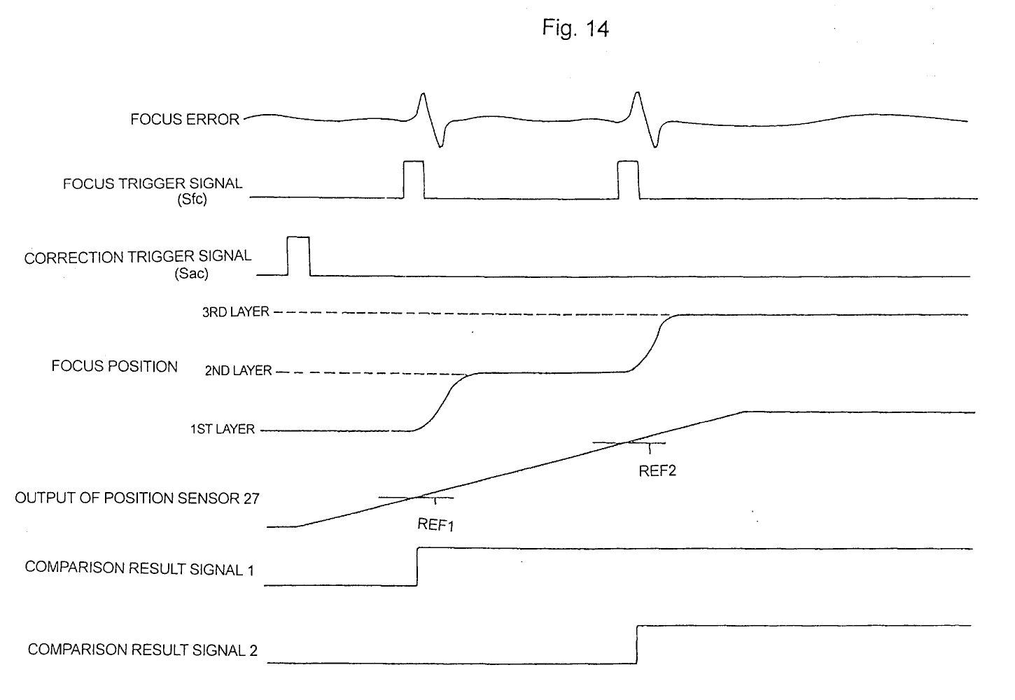

FIG. 14 shows the signal waveforms of respective units of the focus control system in the case of gradually performing the focus jump as described above. In this case, FIG. 14 shows an example of employing the above described second control method, namely, a method to detect the actual movement amount of the spherical aberration correcting mechanism by the position sensor 27 and to start the movement of the focus actuator depending the detected movement amount.

As shown in FIG. 14, when the timing controller 10 outputs the correction trigger signal Sac and the spherical aberration correcting mechanism starts to move from the first recording layer to the second recording layer, the level of the detection signal S7 of the position sensor 27 is gradually changed. When the level of the detection signal S7 attains the predetermined reference value REF1, the timing controller 10 determines that the spherical aberration correcting mechanism is moved to an approximate mid point between the first recording layer and the second recording layer, and the timing controller 10 outputs the focus trigger signal Sfc to start the movement of the focus actuator. After that, when the focus actuator is moved on the second recording layer, the focus servo is closed. Therefore, the focus error signal having a waveform of correct S-shape is output, and the spot of the laser light is focused on the second recording layer.

When the spot of the laser light is focused on the second recording layer, the spherical aberration correcting mechanism is still moving to the third recording layer. When the detection signal S7 from the position sensor 27 attains the predetermined reference value REF2, the timing controller 10 outputs the focus trigger signal Sfc again and moves the focus actuator from the second recording layer to the third recording layer. After that, when the focus actuator is moved to the third recording layer, the focus servo is closed and the focus servo operation is performed on the third recording layer, so that the spot of the laser light is kept in focus.

Thus, in the case of performing the focus jump across two or more layers at once in the multi-layer disk having more than two layers, it is possible to correctly perform the focus jump by repeating the method according to the present invention.

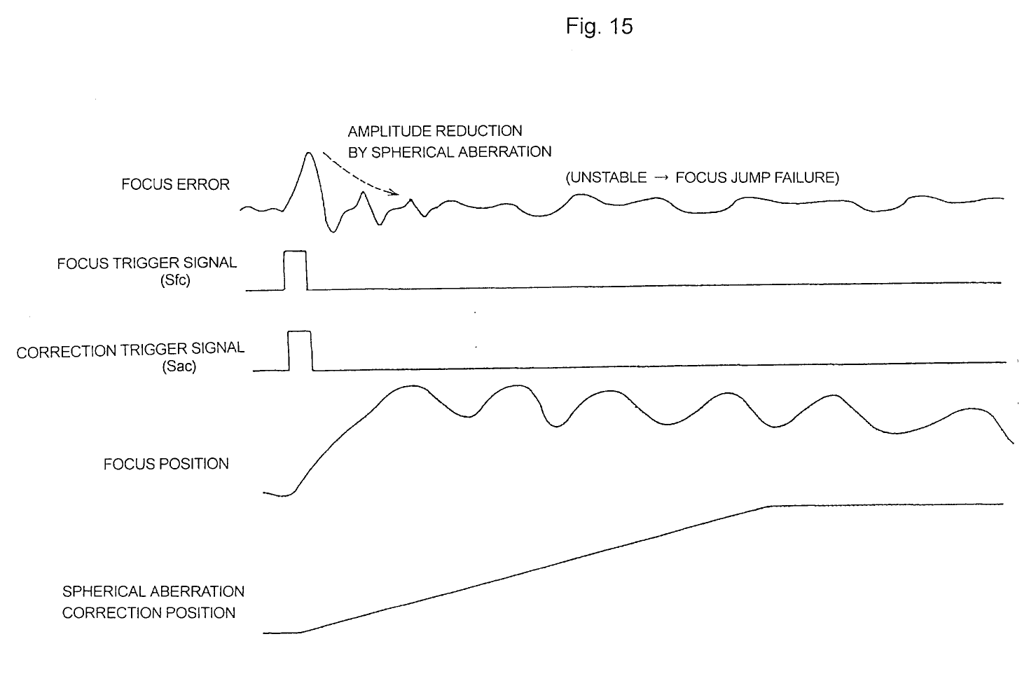

In comparison, FIG. 15 shows signal waveforms of respective units of the focus control system in the case of performing the focus jump from the first recording layer to the third recording layer at once without using the present invention. As shown in FIG. 15, the movement of the focus actuator is started concurrently with the start of the movement of the spherical aberration correcting mechanism. However, since the focus actuator jumps from the first recording layer to the third recording layer under a condition that the spherical aberration correcting mechanism is hardly moved to a position corresponding to a next recording layer, the focus actuator is largely influenced by the spherical aberration and the amplitude of the waveform of the S-shape of the focus error signal is decreased. Therefore, the amplitude of the waveform in the S-shape after closing the focus servo is decreased, and the focus servo after closing the focus servo loop becomes unstable. As a result, the focus jump has failed.

On the contrary, even in the case of jumping not less than two layers, by gradually performing the focus jump from the first recording layer to the second recording layer and then from the second recording layer to the third recording layer, it is possible to realize the stable focus jump.

The above described example is directed to the case that the focus jump not less than two layers is performed by the use of the second control method using the position sensor. However, in the case of using the above described first and third methods, it is also possible to perform the focus jump not less than two layers in the same way. In other words, in the case of using the first method, the focus actuator may be moved to the second recording layer after the predetermined time T has passed after the spherical aberration correcting mechanism starts to move, and then the focus actuator may be further moved to the third recording layer after the predetermined time T has passed. Further, in the case of using the third method, the amplitude values of the RF signal, the tracking error signal or the wobble signal may be compared with the reference amplitude values prepared for the focus jump from the first layer to the second layer and for the focus jump from the second layer to the third layer, respectively.

As described above, according to the present invention, at first the movement of the spherical aberration correcting mechanism is started, and then the movement of the focus actuator is started when the spherical aberration correcting mechanism attains the vicinity of a mid point between the first recording layer and the second recording layer. As a result, it is possible to perform the focus jump stably.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2001-207012 filed on Jul. 6, 2001 including the specification, claims, drawings and summary is incorporated herein by reference in its entirety.

What is claimed is:

1. A multi-layer disk recording/reproducing apparatus for recording information on a multi-layer disk having a plurality of recording layers and/or reproducing information from the multi-layer disk, comprising:
an objective lens which condenses a light from a light source on the recording layers;
a focus actuator which moves the objective lens to form a focused light spot of the light on the recording layers;
a spherical aberration correcting mechanism which is provided on a light path between the light source and the objective lens and which corrects spherical aberration generated by the multi-layer disk; and
a control device which starts a movement of the focus actuator after a start of a movement of the spherical aberration correcting mechanism when performing a focus jump operation to move the light spot from a first recording layer to a second recording layer of the multi-layer disk.

2. A multi-layer disk recording/reproducing apparatus according to claim 1, wherein the control device moves the spherical aberration correcting mechanism from a position corresponding to the first recording layer to a position corresponding to the second recording layer, and starts the movement of the focus actuator when the spherical aberration correcting mechanism is moved to an approximate mid point between the position corresponding to the first recording layer and the position corresponding to the second recording layer.

3. A multi-layer disk recording/reproducing apparatus according to claim 1, wherein the control device comprises:
a timer which starts counting a time when the movement of the spherical aberration correcting mechanism is started; and
a unit which starts the movement of the focus actuator when a counting time of the timer becomes a predetermined time.

4. A multi-layer disk recording/reproducing apparatus according to claim 3, wherein the predetermined time is substantially equivalent to ½ of a time required for the movement of the spherical aberration correcting mechanism from the position corresponding to the first recording layer to the position corresponding to the second recording layer.

5. A multi-layer disk recording/reproducing apparatus according to claim 1, further comprising a position sensor which detects a movement amount of the spherical aberration correcting mechanism;
wherein the control device starts the movement of the focus actuator based on the output of the position sensor.

6. A multi-layer disk recording/reproducing apparatus according to claim 1, further comprising:
a photo detector which receives a returned light from the multi-layer disk and outputs an electrical signal; and
a unit which generates a reproduction signal or a control signal of recorded information based on the electrical signal;
wherein the control device starts the movement of the focus actuator based on a change in an amplitude of the reproduction signal or the control signal.

7. A multi-layer disk recording/reproducing apparatus according to claim 6, wherein the reproduction signal includes an RF signal and the control signal includes a tracking error signal and a wobble signal.

8. A multi-layer disk recording/reproducing apparatus according to claim 1, wherein the spherical aberration correcting mechanism comprises:
a moving mechanism which moves at least one lens of a plurality of lenses arranged in parallel with each other on a light axis; and
a driving motor which drives the moving mechanism.

9. A multi-layer disk recording/reproducing apparatus according to claim 8, wherein the driving motor comprises a step motor, and the control device comprises:
a unit for driving the moving mechanism by inputting pulses to the step motor; and
a unit which starts the movement of the focus actuator based on a number of pulses which have been input to the step motor.

10. A multi-layer disk recording/reproducing apparatus according to claim 1, wherein the spherical aberration correcting mechanism comprises:
a liquid crystal panel having a plurality of liquid crystal portions controlled independently of each other; and
a control circuit which drives the plural liquid crystal portions independently of each other, wherein the spherical aberration correcting mechanism controls a refraction index of the plural liquid crystal portions by applying a voltage to the plural liquid crystal portions independently to correct the spherical aberration.

11. A focus jump method of moving a light from a first recording layer to a second recording layer of the multi-layer disk by means of a multi-layer disk recording/reproducing apparatus comprising: an objective lens which condenses a light from a light source on the recording layers; a focus actuator which moves the objective lens to form a focused light spot of the light on the recording layers; a spherical aberration correcting mechanism which is provided on a light path between the light source and the objective lens and which corrects spherical aberration generated by the multi-layer disk, the focus jump method comprising the steps of:
a first step of starting a movement of the spherical aberration correcting mechanism corresponding to the first recording layer to a position corresponding to the second recording layer when a timing a focus jump has arrived; and
a second step of starting a movement of the focus actuator starting the movement of the focus actuator after the movement of the spherical aberration correcting mechanism.

12. A focus jump method according to claim 11, wherein the second step starts the movement of the focus actuator when a predetermined time has passed after a start of the movement of the spherical aberration correcting mechanism, and wherein the predetermined time is substantially equivalent to ½ of a time required for the movement of the spherical aberration correcting mechanism from the position corresponding to the first recording layer to the position corresponding to the second recording layer.

13. A focus jump method according to claim 11, wherein the second step starts the movement of the focus actuator when the spherical aberration correcting mechanism is moved to an approximate mid point between the position corresponding to the first recording layer and the position corresponding to the second recording layer.

14. A focus jump method according to claim 11, wherein the second step comprises the steps of:
detecting an amplitude of a reproduction signal or a control signal of recorded information generated based on a returned light from the multi-layer disk; and
starting the movement of the focus actuator when the amplitude becomes equal to an amplitude which is obtained when the spherical aberration correcting mechanism arrives at the approximate mid point between the position corresponding to the first recording layer and the position corresponding to the second recording layer.

15. A multi-layer disk recording/reproducing apparatus for recording information on a multi-layer disk having a plurality of recording layers or reproducing the information from the multi-layer disk, comprising:
an objective lens which condenses a light from a light source on the recording layers;
a focus actuator which moves the objective lens to form a focused light spot of the light on the recording layers; and
a control device which performs a focus jump to an adjacent recording layer by moving the focus actuator from a present recording layer to the adjacent recording layer and making the light spot in focus on the adjacent recording layer, and performs the focus jump across three or more recording layers by repeating the focus jump to the adjacent recording layer.

16. A multi-layer disk recording/reproducing apparatus for recording information in a multi-layer disk having a plurality of recording layers or reproducing the information from the multi-layer disk, comprising:
an objective lens which condenses a light from a light source on the recording layers;
a focus actuator which moves the objective lens to form a focused light spot of the light on the recording layers
a spherical aberration correcting mechanism which is provided on a light path between the light source and the objective lens and corrects spherical aberration generated by the multi-layer disk; and
a control device which performs a focus jump across three or more recording layers by moving the spherical aberration correcting mechanism toward a position corresponding to a target recording layer and repeating an operation for moving the focus actuator to a next recording layer when the spherical aberration correcting mechanism arrives at an approximate mid point between a position corresponding to the present recording layer and a position corresponding to the next recording layer.
